(19) United States
(12) Patent Application Publication
(10) Pub. No.: US 2014/0306824 A1
(43) Pub. Date: Oct. 16, 2014

(54) LED security sensor

(71) Applicant: Royne Industries, LLC dba Nascom, La Jolla, CA (US)

(72) Inventors: Christopher Pritchett, San Diego, CA (US); Kevin Ruckley, San Diego, CA (US)

(21) Appl. No.: 14/250,376

(22) Filed: Apr. 10, 2014

Related U.S. Application Data
(60) Provisional application No. 61/810,577, filed on Apr. 10, 2013.

(51) Int. Cl. G08B 13/08

(52) U.S. Cl. CPC G08B 13/08
USPC 340/545.2

(57) ABSTRACT

A door sensor system comprising door sensor circuit and a sensor support circuit.

### FIELD OF THE INVENTION

The present invention relates to security systems.

### BRIEF DESCRIPTION OF THE DRAWINGS

The present invention will be described by way of exemplary embodiments, but not limitations, illustrated in the accompanying drawings in which like references denote similar elements, and in which:

The accompanying drawings, which are incorporated into and constitute a part of this specification, illustrate one or more embodiments of the invention and, together with the detailed description, serve to explain the principles and implementations of the invention.

FIG. 1 shows an exemplary embodiment of a door sensor system in accordance with the invention.

FIG. 2 shows the door sensor circuit that is part of the door sensor system.

FIG. 3 shows a comparator circuit that is part of the sensor support circuit.

FIG. 4 shows an XOR Gate and an IC Switch, both part of the sensor support circuit.

### DETAILED DESCRIPTION

Before beginning a detailed description of the subject invention, mention of the following is in order. When appropriate, like reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various Figures and are not intended to impose limitations on any position and/or orientation of any embodiment of the invention relative to any reference point external to the reference.

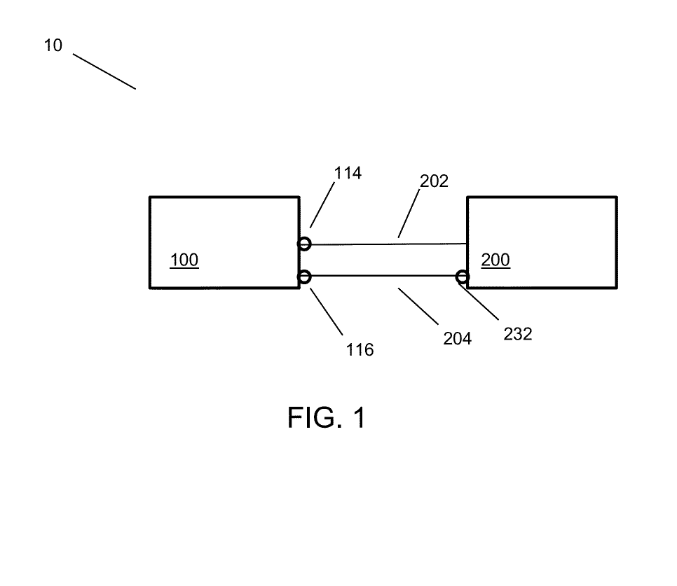

FIG. 1 shows an exemplary embodiment of a door sensor system 10 in accordance with the invention. The door sensor system 10 has a door sensor circuit 100 connected to a sensor support circuit 200 with a voltage supply wire 202 and a sensor output wire 204.

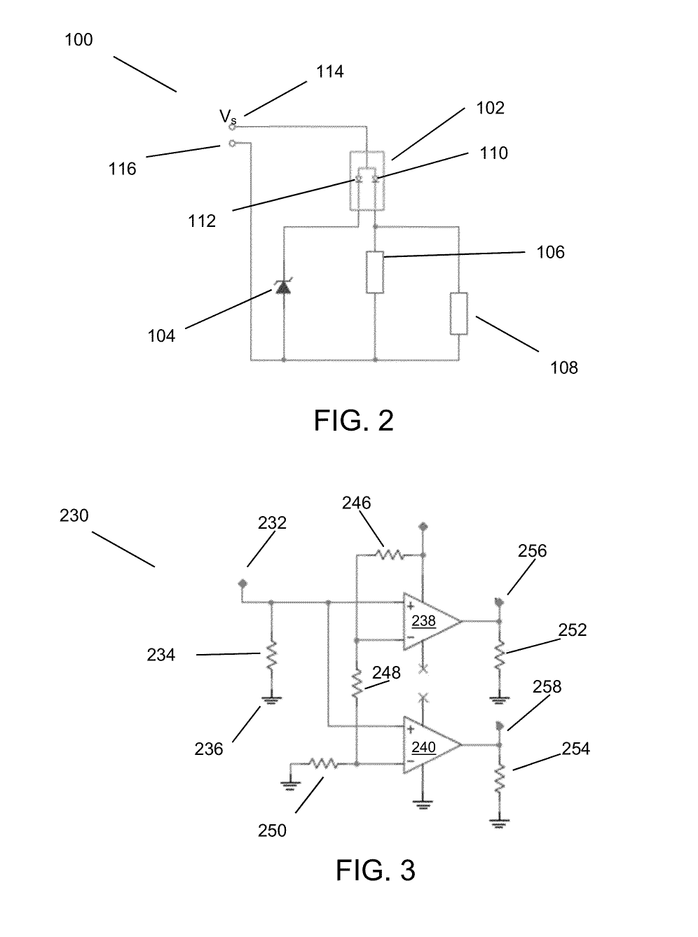

FIG. 2 shows the door sensor circuit 100. The door sensor circuit 100 is typically enclosed in some type of housing, preferably with anti-tamper features. The housing with the enclosed door sensor circuit 100 is configured to be mounted to a door frame for the purpose of monitoring whether the door is open or shut.

The door sensor 100 has a supply voltage terminal 114 and a sensor output terminal 116 configured to electrically connect with a sensor support circuit 200, typically with a pair of wires. The supply voltage terminal 114 is configured to connect with a supply voltage Vₛ in the sensor support circuit 200. In the exemplary embodiment, the supply voltage is +9 volts, but in other embodiments may be some other positive dc voltage. The sensor output terminal 116 is configured to carry a voltage signal back to the sensor support circuit 200 that indicates whether the door is open or closed.

The door sensor circuit 100 has a LED module 102, a Zener diode 104, and one or more reed switches. The exemplary embodiment has two reed switches—a first reed switch 106 and a second reed switch 108. The LED module 102 has at least two LEDs of different colors. In the exemplary embodiment, the LED module 102 has a first LED 110 configured to emitted light of a first color and a second LED 112 configured to emit light of a second color. In other embodiments the LED module 102 may have more than two LED, each of a different color. In the exemplary embodiment, the first color is blue and the second color is red, but in other embodiments, the LEDs may be of other colors. The anodes of the first LED 110 and second LED 112 are tied together and to connected the supply voltage terminal 114.

The cathode of the first LED 110 is connected to one terminal of the first reed switch 106 and one terminal of the second reed switch 108. If the door sensor circuit 100 has more than one reed switch, then the reed switches 106, 108 are connected in parallel. The other terminals of the reed switches 106, 108 are connected to the sensor output terminal 116. The cathode of the second LED 112 is connected to the cathode of the Zener diode 104.

FIG. 3 shows a comparator circuit 230 that is part of the sensor support circuit 200. The comparator circuit 230 has a comparator input 232 that is configured to connect with the sensor output terminal 116 via the sensor output wire 204. A first resistor 234 is connected between the comparator input 232 and ground 236. The first resistor 234 limits current drawn from the sensor output terminal 116. The comparator circuit 230 has a first op amp 238 and a second op amp 240. The comparator input 232 is connected to the positive inputs of the first op amp 238 and second op amp 240. A third resistor 246, a fourth resistor 248 and a fifth resistor 250 provide appropriate biasing for the op amps so they trigger at the desired input voltages. A sixth resistor 252 and seventh resistor 254 provide current limiting for a first op amp output 256 and second op amp output 258, respectively.

### Operation

The first LED 110 has a first LED on-voltage V_{O1} and the second LED 112 has a second LED on-voltage V_{O2}. When the voltage across an LED is at or above its on-voltage, the LED illuminates, but below its on-voltage, the LED does not illuminate. In addition, the Zener diode 104 has a breakdown voltage V_{B} above which the Zener diode 104 will pass current, but below which, it will block current. The values of the first LED on-voltage V_{O1}, second LED on-voltage V_{O2}, the supply voltage V_{S}, and the Zener diode breakdown voltage V_{B} are selected such that the combination of the breakdown voltage V_{B} with the first LED on-voltage V_{O1} is less than the supply voltage V_{S}, but greater than the first LED on-voltage V_{O1}. Thus when either first reed switch 106 or second reed switch 108 is closed, the first LED 110 illuminates but the second LED 112 is unilluminated. When both the first reed switch 106 and second reed switch 108 are open, the second LED 112 illuminates but the first LED 110 is unilluminated. The switch open condition will produce a greater voltage drop from the supply voltage terminal 114 to the sensor output terminal 116 than if one of the switches 106, 108 is closed. Thus the voltage at the sensor output terminal 116 and comparator input 232 is lower for the open switch condition than it is for the closed switch position.

If the voltage supply wire 202 and sensor output wire 204 connecting the door sensor circuit 100 to the sensor support circuit 200 are shorted together in an attempt to tamper and bypass the sensor, neither the first LED 110 nor second LED 112 will illuminate. Also, the voltage at the comparator input 232 will be the undiminished supply voltage Vₛ, which will allow the sensor support circuit 200 to distinguish between the switch open/switch closed conditions and a tempering condition.

For a “door open” event both the first op amp 238 comparator and second op amp 240 comparator give a “low” signal value. For a “door closed” event one op amp comparator gives a “low” signal value while the other gives a “high” signal value. If the wires 202, 204 between the door sensor circuit 100 and sensor support circuit 200 are tampered and shorted together both comparators return a “high” signal value.

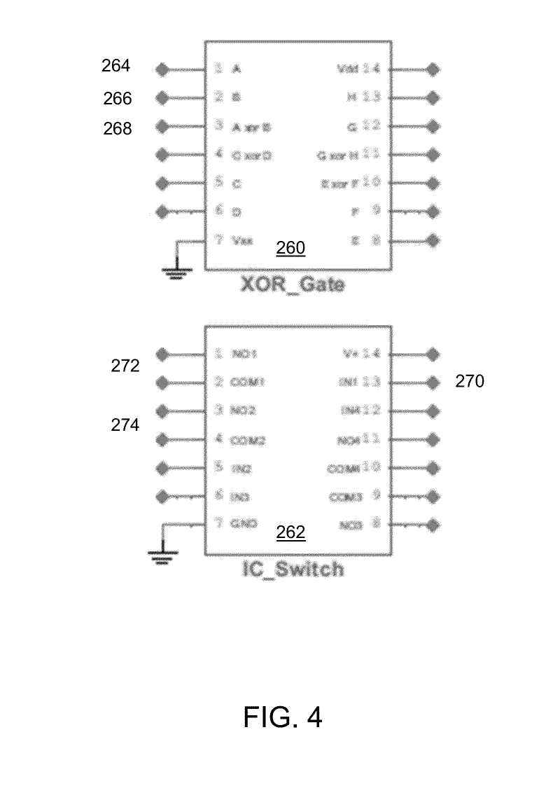

FIG. 4 shows an XOR Gate 260 and an IC Switch 262, both part of the sensor support circuit 200. The first op amp output 256 is connected to a first XOR Gate input 264 and the second op amp output 258 is connected to a second XOR Gate input 266. An XOR gate output 268 will only output a high signal value for a closed door event. The XOR Gate output 268 is connected to an IC Switch input 270. The IC Switch input 270 has an IC Switch first output 272 and an IC Switch second output 274. The IC Switch first output 272 and IC Switch second output 274 close when there is a door closed event and open during an open door or tampered event. These two outputs are wired out to the security controller zone inputs to accurately communicate to the controller the status of the door sensor circuit.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

What is claimed is:

1. A door sensor system comprising:
door sensor circuit; and
sensor support circuit.
